(19) United States
(12) Patent Application Publication
(10) Pub. No.: US 2007/0107235 A1
(43) Pub. Date: May 17, 2007

(54) Light assembly for circular saw

(75) Inventor: Kwok Ting Mok, Tokwawan (HK)

Correspondence Address: BRINKS HOFER GILSON & LIONE, P.O. BOX 10395, CHICAGO, IL, 60610, US

(73) Assignee: Eastway Fair Company Limited of Trident Chambers

(21) Appl. No.: 11/274,445

(22) Filed: Nov. 15, 2005

(51) Int. Cl. B26B 15/00

(52) U.S. Cl. 30/264

(57) ABSTRACT

A circular saw includes a motor operatively connected to rotate a saw blade that forms a cutting plane and a fixed blade guard that surrounds a portion of the saw blade. The circular saw additionally includes at least one light source that is mounted to the fixed blade guard and emits a beam that forms a first linear optical alignment marker on a workpiece in a first direction, and emits a beam that forms a second linear optical alignment marker on the workpiece in a substantially second opposite direction.

### BACKGROUND

The present invention relates to power tools, and in particular to a circular saw. Additionally, the present invention relates to a circular saw with a light source provided to illuminate the cutting line of the saw. The circular saw of the present invention improves on previous designs because it includes a light or a plurality of lights that illuminate the cutting line both in front of and behind the saw blade.

### BRIEF SUMMARY

The present invention provides a light assembly for a circular saw. The circular saw includes a motor operatively connected to rotate a saw blade that forms a cutting plane and a fixed blade guard that surrounds a portion of the saw blade. The circular saw additionally includes at least one light source mounted to the fixed blade guard to emit a beam that forms a first linear optical alignment marker on a workpiece in a first direction and emits a beam that forms a second linear optical alignment marker on a workpiece in a second substantially opposite direction.

Advantages of the present invention will become more apparent to those skilled in the art from the following description of the preferred embodiments of the invention that have been shown and described by way of illustration. As will be realized, the invention is capable of other and different embodiments, and its details are capable of modification in various respects. Accordingly, the drawings and description are to be regarded as illustrative in nature and not as restrictive.

### BRIEF DESCRIPTION OF THE DRAWINGS

FIG. 1 is a perspective view of one embodiment of a laser assembly of the present invention for a circular saw.

FIG. 2 is a second perspective view of the light assembly and circular saw of FIG. 1.

FIG. 3 is the view of the circular saw of FIG. 1 with a portion of the fixed blade guard removed.

FIG. 4 is an exploded view of the circular saw of FIG. 1 showing the components forming the light source.

FIG. 5 is an additional perspective view of the laser assembly of FIG. 1.

FIG. 6 is a perspective view of another embodiment of the laser assembly of the present invention mounted on a circular saw.

FIG. 7 is an exploded view of the circular saw of FIG. 6 showing the components forming the rotatable light.

FIG. 8 is a cross-sectional view of another embodiment of the laser assembly of the present invention mounted on a circular saw.

### DETAILED DESCRIPTION

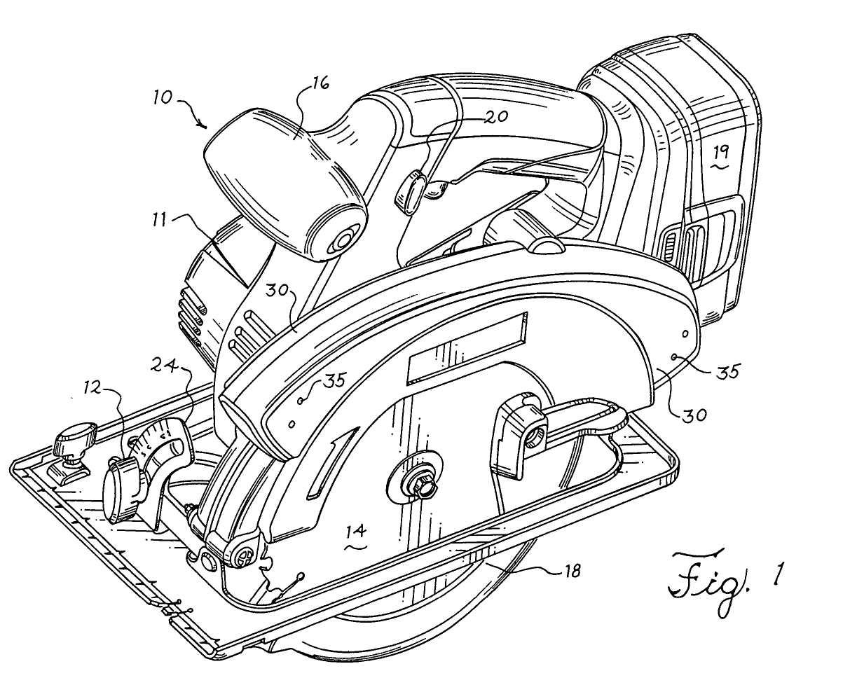

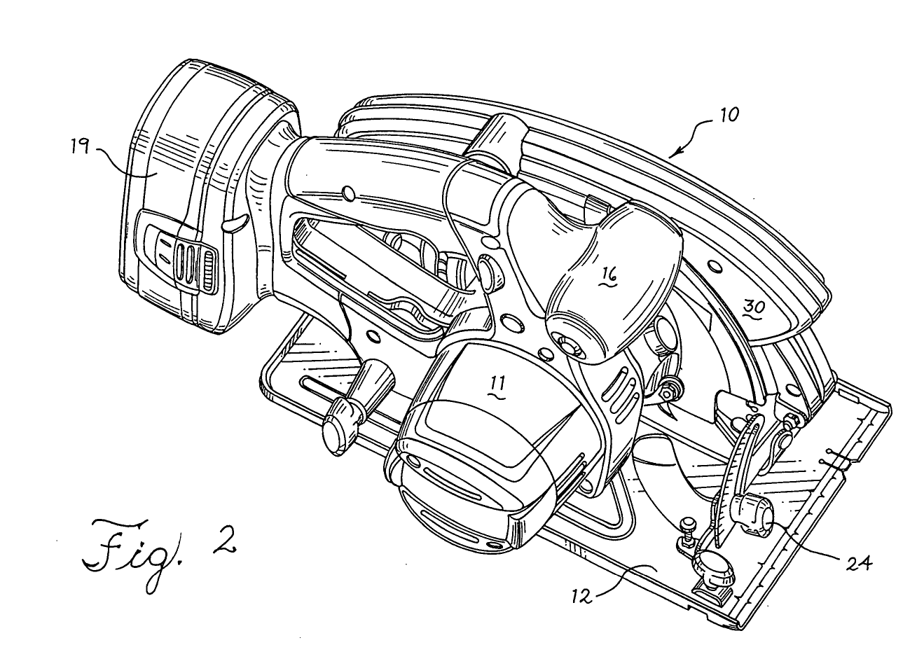

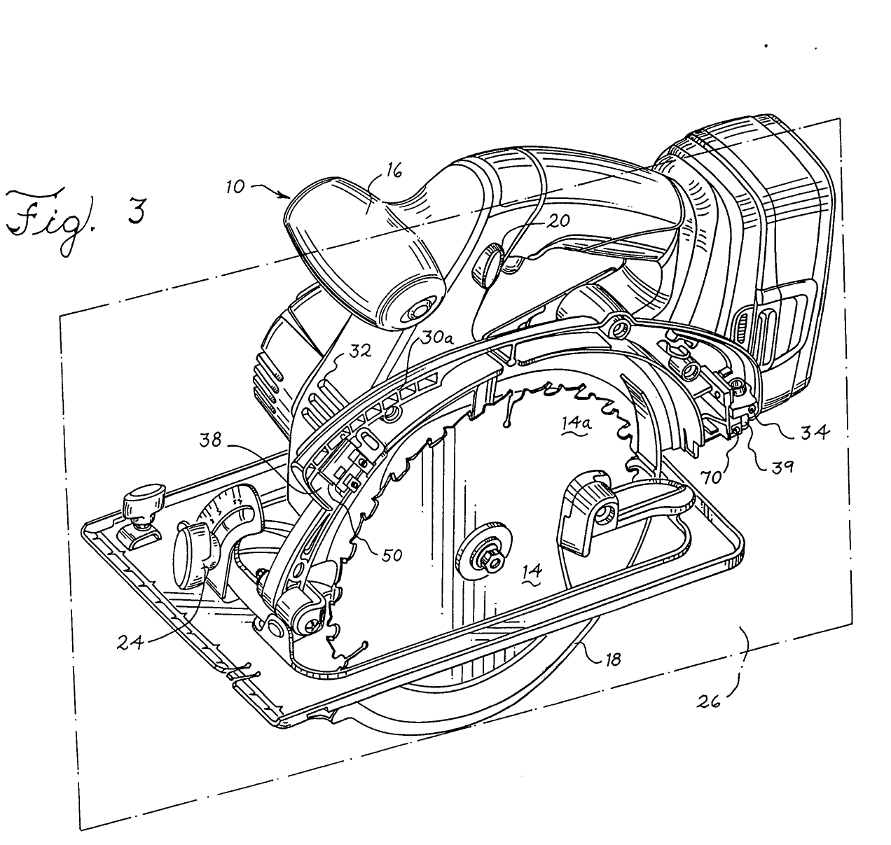

Referring now to FIGS. 1-5, a first embodiment of a laser assembly mounted on a circular saw 10 is provided. The circular saw includes all of the components of conventional circular saws, including a motor (not shown) that is rotatably mounted to a saw blade 14 and surrounded by a housing 11. As understood with reference to FIG. 3, a cutting plane 26 is formed that extends through the center plane of the saw blade 14. The housing 11 includes a handle 16 and is preferably pivotably mounted to a base plate 12 to allow the cutting depth of the saw blade 14 to be adjusted. Additionally, a trunnion plate 24 may be provided that extends from the base plate 12 and receives a post (not shown) that is connected to the housing 11 to allow the saw blade 14 to be retained within a range of bevel angles with respect to the base plate 12. The circular saw includes a motor switch 20 that operatively connects the motor to a source of electrical current, either from an external AC source, or with a DC source from a rechargeable battery 19 that may be releasably mounted to the circular saw 10.

A fixed blade guard 30 is mounted to the housing 10 and positioned to enclose a portion of the saw blade 14. As shown in FIG. 3, the fixed blade guard 30 is mounted to enclose a top portion 14a of the saw blade 14 to prevent the user from contacting the rotating saw blade 14 during operation of the circular saw. In some embodiments, a lower blade guard 18 may be pivotally attached to the fixed blade guard 30. The lower blade guard 18 is normally slidably attached to the fixed blade guard 30 and biased to a position where the lower blade guard 18 encloses a bottom portion (not shown) of the saw blade. As is understood by those of skill in the art, the lower blade guard 18 normally covers the bottom portion of the saw blade 14 and retracts into the fixed blade guard 30 when the circular saw encounters a workpiece (not shown) to be cut at front end of the circular saw 10.

Referring to FIGS. 1 and 3, the fixed blade guard 30 is preferably formed from two clam shell halves (with one of the two halves 30a shown in FIG. 3, and the assembled fixed blade guard 30 shown in FIG. 1). In some embodiments, the fixed blade guard 30 is formed with a front cavity 32 and a rear cavity 34. The front cavity 32 can receive a forward light source 50 and the rear cavity 34 can receive a rear light source 70. Each of the front and the rear cavities 32, 34 include a window 38, 39 respectively, to provide an opening for a light beam emitted from the respective light source 50, 70.

In some embodiments, the windows 38, 39 may be formed with an opening in the surface of the fixed blade guard 30 to allow the light beam to escape. In other embodiments, the windows 38, 39 may be formed from clear plastic, glass or other substantially transparent materials. In other embodiments, the lower blade guard 18 includes a slot (not shown) to allow the light beam to escape the lower blade guard 18.

Each of the forward light source 50 and the rear light source 70 are formed with the same components and attached to the fixed blade guard 30 in the same manner. Therefore, only one of the light sources will be fully described with the element numbers being the same for the same components in both the front and rear light sources 50, 70.

Each of the front and rear light sources 50, 70 are preferably provided with laser generators that emit a planar light or beam. The light sources 50, 70 include a laser that emits a beam that is converted to a planar laser source with a lens. In other embodiments, the light sources 50, 70 may be provided with LEDs or other types of lights from which a planar light can be emitted.

Each of the light sources 50, 70 includes a light emitter 60, a housing 52 that surrounds a majority of the light emitter 60 and is movable with respect to the fixed blade guard 30, and structure to allow for desired movement of the light sources 50, 70 with respect to the fixed blade guard 30.

The light emitters 60 may be powered from the same power source as the circular saw motor (not shown) or may be powered from a power source different than that which powers the motor. The power source can be AC power with the current to operate the light emitters 60 being transformed and rectified to useable DC current as is understood by those of ordinary skill in the art. The power source can also be DC power from a variety of sources, including rechargeable batteries.

The front light source 50 and the rear light source 70 may be operated by a light switch 22 that is mounted to the housing 11 or may be operated upon actuation of the motor switch. In other words, the light sources 50, 70 can be operated independently from the operation of the saw blade 14 can be wired to be operated whenever the motor is operates.

The light emitter 60 is partially enclosed and supported within an internal cavity 52b within the housing 52. The housing 52 surrounds a side circumference surface 60a of the light emitter 60 and includes the structure to rigidly support the light emitter 60 with respect to the housing 52, as discussed below. The housing includes an opening 52a that allows the light emitted from the light emitter 60 to exit the respective light source 50, 70 and be directed toward the workpiece.

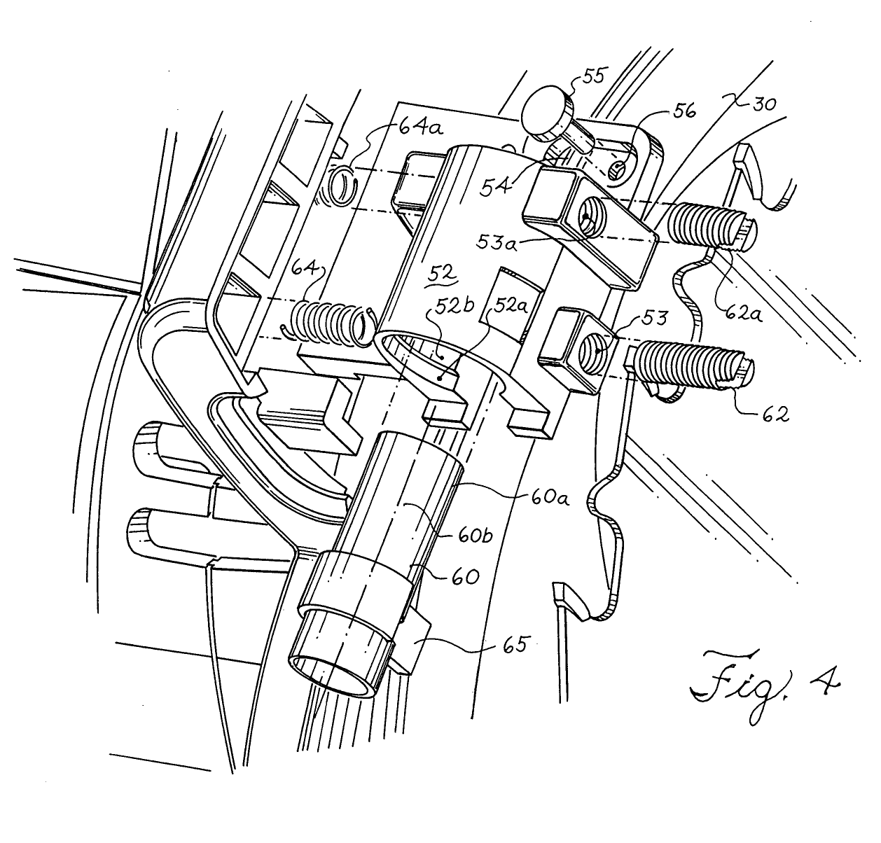

A lateral slot 54 extends from the housing 52 opposite from the opening 52a. The slot is oriented perpendicular to the length of the housing 52. The slot 54 receives a fastener 55 (FIG. 4) that extends through the slot 54. The fixed blade guard 30 includes a hole 56 that receives the fastener 55. Because the fastener 55 is fixed to the fixed blade guard 30, the length of the lateral slot 54 establishes the limits of movement of the respective light source 50, 70 in a direction substantially perpendicular to the cutting plane 26 of the saw blade 14.

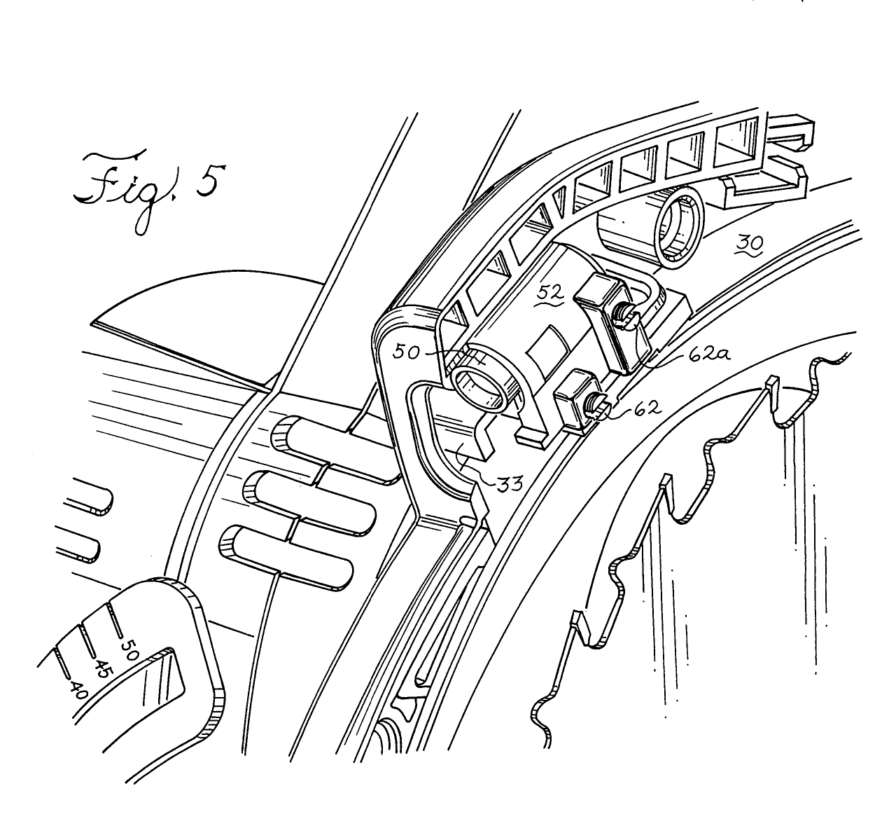

The light emitter 60 may be adjustably mounted to the housing 52 with at least one screw 62 as shown in FIGS. 4 and 5. The screw 62 is rotatably inserted into a tapped aperture 53 within the housing 52. The screw 62 is accessible for rotation when the fixed blade guard 30 is assembled because the fixed blade guard 30 includes a plurality of apertures 35 positioned in-line with each of the screws 62 to allow the user to rotate each screw 62 without disassembling the fixed blade guard 30.

In the embodiments shown in FIGS. 4 and 5, a first screw and a second screw 62, 62a are provided for each housing 52. A first screw 62 is rotatably inserted into a first tapped aperture 53 that is in line with a tab 65 (best shown in FIG. 4) in the light emitter 60. The tab 65 extends from the bottom side of the light emitter 60 and extends downward into the housing 52 when the light emitter 60 is positioned within the housing 52. An end of the first screw 62 engages the tab 65 when the first screw 62 is sufficiently inserted into the first tapped aperture 53. A first spring 64 is positioned between the opposite side of the tab 65 and a wall of the housing 52 opposite the wall with the tapped aperture 53. The first spring 64 is compressed with all positions of the tab 65 to constantly bias the tab 65 toward the first screw 62.

Rotation of the first screw 62 in a first direction causes motion of the first screw 62 toward the tab 65, which causes the light emitter 60 to rotate in a first direction about the longitudinal axis 60b of the light emitter 60 and further compresses the first spring 64. Rotation of the first screw 62 in the opposite direction causes motion away from the tab 65, which causes the light emitter 60 to rotate in the opposite direction and partially decompressing the first spring 64. The threaded connection between the first screw 62 and the first tapped aperture 53 in the housing retains the light emitter 60 in the selected rotational position.

The housing 52 includes a second tapped aperture 53a that is positioned to receive a second screw 62a. The second tapped aperture 53a is oriented rearward of the first tapped aperture 53 and preferably in-line with a longitudinal axis 60b of the light emitter 60. A second screw 62a is inserted within the second tapped aperture 53a to contact the body section 60a of the light emitter 60 along its longitudinal axis 60b rearward of the tab 65. A second spring 64a is provided within the housing 52 and positioned in-line with the second screw 62a and between the housing 52 and the light emitter 60 on the opposite side from where the second screw 62a contacts the light emitter 60. The second spring 64a is compressed with all positions of the second screw 62a to urge the light source in the horizontal direction perpendicular for the longitudinal axis 60b of the light emitter 60.

Rotation of the second screw 62a in a first direction causes motion of the second screw 62a toward the light emitter 60 causing lateral motion of the light emitter 60 away from the second tapped aperture and further compressing the second spring 64a. Rotation of the second screw 62a in the opposite direction causes reverse motion of the second screw 62a and allows the biasing force of the second screw 64a to cause lateral motion of the light emitter 60 toward the second tapped aperture 53a. The threaded connection between the second screw 62a and the second tapped aperture 53a retains the light emitter 60 in the selected lateral position.

Normally, the forward and rear light sources 50, 70 are aligned so that the linear optical alignment marker that is emitted from each of the light sources 50, 70 is coplanar with the cutting plane 36. Often during use, the circular saw 10 is subjected to vibration and mechanical shock that may over time change the alignment of the forward and rear light sources 50, 70 so that the optical alignment marker that is emitted from each no longer is coplanar with the cutting plane 26. When the light sources 50, 70 need to be adjusted, the first and second screws 62, 62a may be selectively rotated to maintain the planar light beam emitted form the light emitter 60 in parallel with the cutting plane 26, and to finely adjust the lateral position of light beam emitted from the light emitter 60 to maintain the planar light beam within the cutting plane 26, as discussed above.

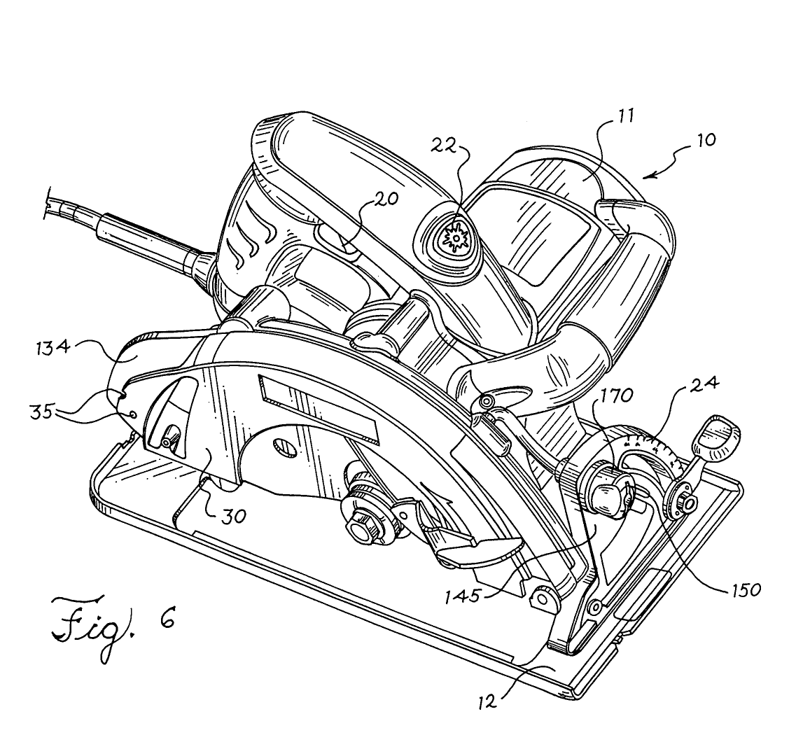

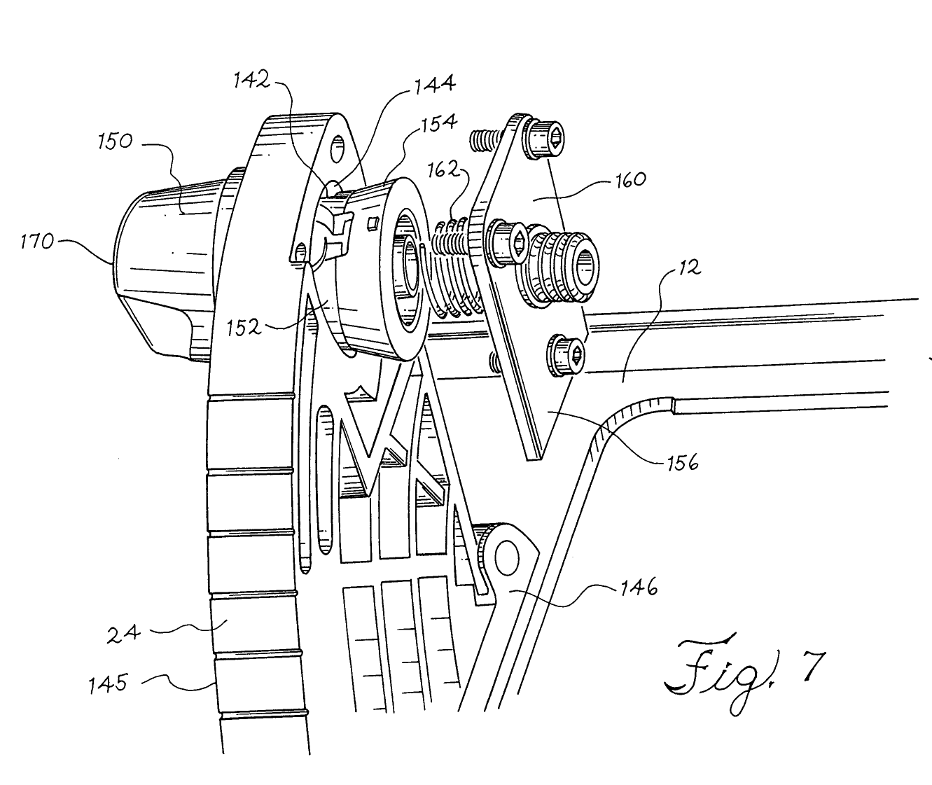

As shown in FIGS. 6 and 7 a second embodiment of a laser assembly mounted on a circular saw 10 is provided. The second embodiment includes all of the components of conventional circular saws, including a motor (not shown) that is rotatably mounted to a saw blade 14 that forms a cutting plane 26 and surrounded by a housing 11. The housing 11 includes a handle 16 and is preferably pivotably mounted to a base plate 12 to allow the cutting depth of the saw blade 14 to be adjusted. Additionally, a trunnion plate 24 may be provided that extends from the base plate 12 and receives a post (not shown) that is connected to the housing 11 to allow the saw blade 14 to be retained within a range of bevel angles with respect to the base plate 12. The circular saw includes a motor switch 20 that operatively connects the motor to a source of electrical current, either from an external AC source, or with a DC source from a rechargeable battery that may be releasably mounted to the circular saw 10.

A fixed blade guard 130 is mounted to the housing 10 and positioned to enclose a portion of the saw blade 14. As with the embodiment discussed above, the fixed blade guard 130 is mounted to enclose a top portion of the saw blade 14 to prevent the user from contacting the rotating saw blade 14 during operation of the circular saw. In some embodiments, a lower blade guard (shown in FIG. 3) may be pivotally attached to the fixed blade guard 130 as discussed in the embodiment above.

Referring to FIG. 3 of the previous embodiment, the fixed blade guard 130 (as shown as 30 in FIG. 3) is formed from two clam shell halves. The fixed blade guard 130 includes a cavity 134, which is constructed in the same manner as the cavity 32, 34 that are described in the above embodiment. Specifically, the cavity 134 encloses a light source 50 that emits a linear optical alignment marker through a window 39 and is positioned within a housing 52 that is adjustable with the use first and second screws 62, 62a and first and second springs 64, 64a as discussed above in the previous embodiment. The cavity 134 can be positioned on either the front end of the fixed blade guard 130 to provide light from the light source 50 in front of the circular saw 10, or alternatively (as shown in FIG. 6), the cavity 134 can be positioned on the rear end of the fixed blade guard 130 to provide a light from the light source 50 behind the circular saw 10.

A rotatable light 150 that is mounted to the trunnion plate 24 can be secured in a selected orientation. The rotatable light 150 emits a planar light beam that forms a linear optical alignment marker when it contacts a workpiece. Because the rotatable light 150 is rotatably securable on the trunnion plate 24, the rotatable light 150 can provide a plurality of different functions depending on its orientation. The figures show a rotatable light 150 that is mounted on the trunnion plate 24 to emit a light in front of the circular saw 10. It should be understood that the rotatable light 150 and associated components, discussed below, for rotatably mounting the light source on the trunnion plate 24 can be oriented oppositely so the rotatable light 150 can emit a light behind the circular saw 10.

For example, the rotatable light 150 can be rotated so that the linear optical alignment marker is along the same plane with the cutting plane 26 when the base 12 of the circular saw 10 is on the workpiece. Alternatively, the rotatable light 150 may be rotated such that the linear optical alignment marker is parallel but offset from the cutting plane by a predetermined distance, which allows the linear optical alignment marker to serve as a virtual edge guide, which is a substitute for a fence (not shown). Thus, if the user moves the saw along the workpiece such that the linear optical alignment marker is co-linear with an edge of the workpiece, the saw will precisely make the intended cut on the workpiece.

The rotatable light 150 may be constructed with a laser generator that emits a planar beam, or alternatively from an LED or other type of light source known to those of skill in the art. The rotatable light 150 and the rear light source 134 may be operated with a dedicated light switch 22 located on the housing to allow for operation of the lights independently of the motor. In other embodiments, the light may be operated with the motor.

The structure to mount the rotatable light 150 to the trunnion plate 24 is shown in FIG. 7. The rotatable light 150 includes a body section 152 that is inserted into an aperture 142 in the trunnion plate 24. The aperture 142 is formed with a tapered surface 144. The tapered surface 144 is conical in that the diameter of the aperture 142 on the rear side 146 of the trunnion 24 is greater than the diameter of the aperture 142 at the front side 145 of the trunnion 24. The body section 152 includes a conical section 154 that corresponds to the tapered surface 144 of the aperture such that the body section 152 fits tightly within the aperture 142 when the body section 152 is inserted into the trunnion plate 24.

The body section 152 of the rotatable light 150 may be maintained within the trunnion plate 24 with a plate 160 that is connected to the rear side 146 of the trunnion plate 24. A spring 162 is positioned between the rear end 156 of the body section 152 and the plate 160 to bias the body section 152 such that the conical surface 154 of the body section 152 is inserted into the tapered surface 144 of the aperture in the trunnion plate 24. The rotatable light 150 can be freely rotated with respect to the trunnion plate 24 by urging the body section 152 rearwardly with respect to the trunnion plate 24 against the biasing force of the spring 162 until the conical surface 154 no longer contacts the tapered surface 144. When the rotatable light 150 is positioned such that the linear optical alignment marker is located on the desired position on the workpiece, the user releases the body section 152, which moves through the trunnion plate 24 due to the biasing force of the spring 162 until the conical surface 154 of the body section 152 engages the tapered surface 144 of aperture 142. In this position, the spring 162 remains compressed and exerts a forward force on the body section 152, which frictionally engages body section 152 and the trunnion plate 24 that aids in retaining the rotatable light 150 in the selected position.

The front end of the rotatable light 150 is attached to a cap 170. The cap 170 provides an ergonomic surface for the user to manipulate to precisely rotate the rotatable light 150 and change the position of the linear optical alignment marker with respect to the workpiece. The cap 170 also allows the user to move the rotatable light 150 rearwardly with respect to the trunnion plate 24. As discussed above, this rearward motion against the forward biasing force of the spring 162 disengages the contact between the conical surface 154 of the body section 152 and the tapered surface 144 of the trunnion plate 24 and allows the rotatable light 150 to be rotated to a new position. When the rotatable light 150 is in the desired position, the user releases the cap 170 allowing the spring 162 to reposition the body section 152 with respect to the trunnion plate 24 to retain the rotatable light 150 in the desired position.

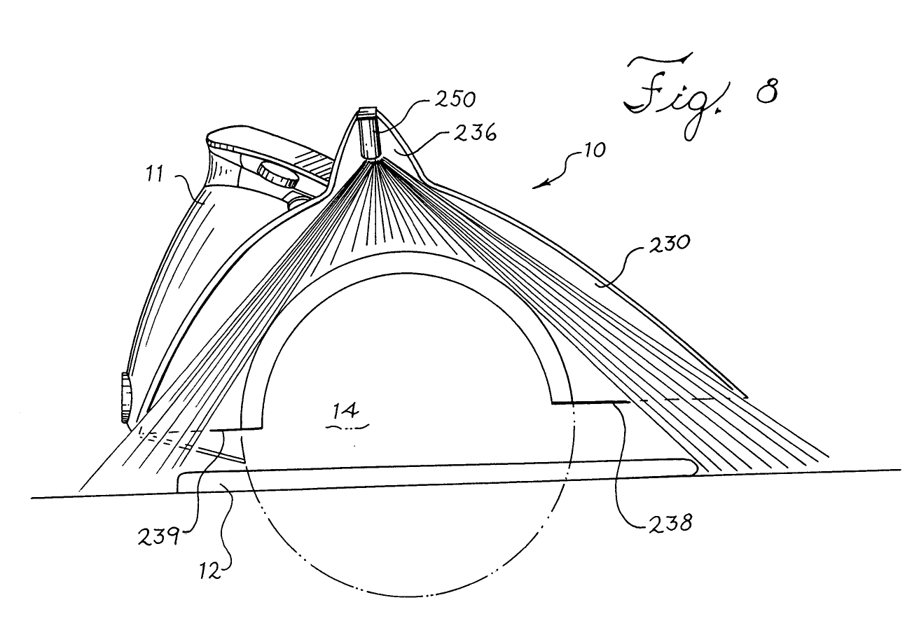

A third embodiment of a laser assembly mounted on a circular saw 10 is provided as shown in FIG. 8. The circular saw 10 includes the components that are found on a conventional circular saw, including a motor (not shown) that is enclosed within a housing 11 and rotates a saw blade 14 through a cutting plane 26. The circular saw 10 includes a base 12 that is the surface that contacts the workpiece when it is being cut and a handle 16.

The circular saw 10 includes a fixed blade guard 230 that encloses a top portion of the saw blade 14 during operation. Additionally, the circular saw includes a lower blade guard (not shown in FIG. 8, but is similar to that shown as 18 in FIGS. 1 and 3) that surrounds the remainder of the saw blade 14 when the circular saw is not cutting a workpiece, and is retractable into the fixed blade guard 230 when performing a cutting operation to expose the lower portion of the saw blade 14.

The circular saw 10 includes a light source 250 that emits a planer light beam, which preferably is a laser beam but can be other types of light sources in other embodiments. Similarly to the above embodiments, the light source 250 may include with a light switch 22 that allows for operation of the light independently from the motor. Alternatively, the light source 250 may be operated with the motor. The light source 250 is constructed and operates similarly to the light sources 50, 70 discussed in detail in the first embodiment above and is formed with a housing (52), a light emitter (60), a plurality of screws (62) and springs (64) that are adjustable to adjust the position of the light source 250 (and therefore the orientation of the linear optical alignment marker that is shined on the workpiece) with respect to the fixed blade guard 230. The fixed blade guard 230 includes a plurality of apertures (similar to element 35 in FIG. 1) that allow for the operation of the screws 62 to position the light source 250 within the fixed blade guard 230.

The light source 250 is oriented within the fixed blade guard 230 such that the single light source 250 provides a linear optical alignment marker both in front of the circular saw and behind the circular saw, as is shown in FIG. 8. The light emitted from the light source 250 shines through each of a front window 238 and a rear window 239 to allow the light to exit the fixed blade guard 230 and contact the workpiece. As with the embodiments discussed above, the windows 238, 239 may be formed by an opening in the surface of the fixed blade guard 230 to allow the light beam to escape, while in other embodiments the windows 238, 239 may be formed from clear plastic, glass, or other substantially transparent, material. In other embodiments, the lower blade guard 18 forms a slot to allow the light beam to escape the lower blade guard.

The light source 250 is positioned within a cavity 236 in the fixed blade guard 230 that provides space for the light source 250 to be oriented to allow the light beam to reach the cutting line both in front of and behind the circular saw 10. In other embodiments, the light source may be positioned differently within the fixed blade guard 230 and provide a linear optical alignment marker both in front of and behind the circular saw 10. For example, the light source 250 may be positioned to emit a first portion of its light beam into a mirror which reflects the light toward the workpiece to provide a linear optical alignment marker either in front of or behind the circular saw, with the light source 250 emitting a second portion of the light beam directly to the workpiece on the opposite side of the circular saw 10. In other embodiments, the light source may emit a first portion of its light beam into a first mirror that reflects the light to provide a linear optical alignment marker in front of the circular saw and emits a second portion of its light beam into a second mirror that reflects the light to provide a linear optical alignment marker behind the circular saw.

It is therefore intended that the foregoing detailed description be regarded as illustrative rather than limiting, and that it be understood that it is the following claims, including all equivalents, that are intended to define the spirit and scope of this invention.

What is claimed:

1. A light assembly for a circular saw comprising:
(a) a motor operatively connected to rotate a saw blade that forms a cutting plane;
(b) a fixed blade guard that surrounds a portion of the saw blade; and
(c) at least one light source mounted to the fixed blade guard to emit a beam in a first direction forward of the saw blade, and to emit a beam in a substantially second opposite direction.

2. The light assembly of claim 1 wherein the at least one light source includes a first light source and a second light source separate from each other.

3. The light assembly of claim 1 for a circular saw wherein the at least one light source is separately operable from the motor.

4. The light assembly of claim 1 wherein the first light source and the second light source each include a housing mounted within the fixed blade guard.

5. The light assembly of claim 4 wherein the housing of the first light source and the housing of the second light source each include a slot and a fastener inserted therethrough that is retained by the fixed blade guard, with the slot establishing the range of motion of the first light source substantially perpendicular to the first direction and establishing the range of motion of the second light source substantially perpendicular to the second direction.

6. The light assembly of claim 1 wherein each of the first light source and the second light source include a first adjustment screw to rotate the respective linear optical alignment marker until it is parallel with the cutting plane.

7. The light assembly of claim 6 wherein each of the first light source and the second light source include a spring positioned opposite from the first adjustment screw to provide a biasing force on the light source opposite the adjustment screw.

8. The light assembly of claim 6 wherein the fixed blade guard includes a plurality of apertures each in-line with the respective first adjustment screw that allows for rotation of the first adjustment screw from outside of the fixed blade guard.

9. The light assembly of claim 6 wherein each of the first light source and the second light source include a second adjustment screw that may be rotated to translate the respective first and second light source in a direction substantially perpendicular to the cutting plane.

10. The light assembly of claim 9 wherein each of the first light source and the second light source additionally include a second spring opposite from the second adjustment screw to provide a biasing force on the each of the light sources opposite from the second adjustment screw

11. The light assembly of claim 9 wherein the fixed blade guard includes a plurality of second apertures in-line with each of the respective second adjustment screws to allow for rotation of the second adjustment screws from outside the fixed blade guard.

12. The light assembly of claim 1 wherein the first light source and the second light source are each lasers.

13. The light assembly of claim 1 wherein the first light source and the second light source are each LEDs.

14. A circular saw comprising:
(a) a motor rotatably connected to a circular saw blade that rotates through a cutting plane;
(b) a fixed saw guard surrounding a portion of the saw blade; and
(c) at least one light source mounted within a housing attached to the fixed saw guard to emit a beam to form a first linear optical alignment marker on a workpiece in a direction substantially forward of the circular saw blade and to emit a beam to form a second linear optical alignment marker on a workpiece substantially rearward of the circular saw blade.

15. The circular saw of claim 14 wherein the at least one light source includes a first light source and a second light source.

16. The circular saw of claim 15 wherein the first light source is mounted within a first cavity within the fixed blade guard and the second light source is mounted within a second cavity within the fixed blade guard.

17. The circular saw of claim 14 wherein each of the first and the second light sources are mounted to the housing with a first screw that allows for rotation of the respective first and the second light sources about a longitudinal axis of the respective first and second light source.

18. The circular saw of claim 17 wherein each of the first and the second light sources are mounted to the housing with a second screw that allows for adjustment of the respective first and the second light sources in a direction substantially perpendicular to the cutting plane.

19. The circular saw of claim 17 wherein the fixed blade guard includes a plurality of apertures that each align with one of the first and second screws to provide for adjustment of each of the first and second screws without removing the fixed blade guard from the circular saw.

20. The circular saw of claim 17 wherein each of the housings enclosing the first and the second light sources further comprise a slot oriented perpendicular to the cutting plane that accepts a fastener, wherein the fixed blade guard comprises a hole that retains the fastener and the movement of the slot with respect to the fastener establishes the limits of travel of the first and the second light sources with respect to the housing.

21. A circular saw comprising:
(a) a motor rotatably connected to a circular saw blade that rotates through a cutting plane;
(b) a base with a slot to receive the saw blade, and a plate that projects from the base;
(c) a fixed blade guard surrounding a portion of the saw blade;
(d) a first light source connected to the fixed blade guard to emit a beam to form a first linear optical alignment marker on a workpiece; and
(e) a second light source mounted to the plate to emit a beam to form a second linear optical alignment marker on the workpiece in a substantially opposite direction form the first linear optical alignment marker.

22. The circular saw of claim 21 wherein the second light source is rotatably mounted on the plate.

23. The circular saw of claim 21 wherein the first linear optical alignment marker is oriented behind the circular saw and the second linear optical alignment marker is oriented in front of the circular saw.

24. The circular saw of claim 21 wherein the first linear optical alignment marker is oriented in front of the circular saw and the second linear optical alignment marker is oriented behind the circular saw.

25. The circular saw of claim 22 wherein the plate includes a tapered aperture and the second light source includes a conical section that are selectively engageable by with a spring to secure the second light source in a selected rotational position.
